(19) United States
(12) Patent Application Publication
(10) Pub. No.: US 2009/0316239 A1
(43) Pub. Date: Dec. 24, 2009

(54) RECORDING APPARATUS AND RECORDING METHOD

(75) Inventors: Hitoshi OKADA, Chiba (JP); Masaaki Hara, Tokyo (JP); Satoru Seko, Kanagawa (JP); Tomiji Tanaka, Saitama (JP); Yoshiki Okamoto, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: Sony Corporation, Tokyo (JP)

(21) Appl. No.: 12/475,098

(22) Filed: May 29, 2009

(30) Foreign Application Priority Data
Jun. 24, 2008 (JP) 2008-164761

(51) Int. Cl. G03H 1/08

(52) U.S. Cl. 359/9

(57) ABSTRACT

A recording apparatus includes a drive unit that rotationally drives a holographic recording medium including a recording layer and a track forming layer that includes guide tracks formed at constant intervals in a radial direction, where a signal beam and a reference beam are emitted to the recording layer so that a hologram is recorded in accordance with the signal beam, a signal beam generating unit, a reference beam generating unit, a recording unit that emits the signal beam and reference beam into the medium and records the hologram, a rotation control unit that controls the drive unit so that the medium is rotationally driven at a constant rotation speed, and a recording control unit that selects some of the guide tracks so that radial-direction recording intervals of the holograms are statistically decreased towards the outer periphery and controls the recording unit to record the holograms along the selected tracks.

### BACKGROUND OF THE INVENTION

1. Field of the Invention

The present invention relates to an apparatus and a method for recording data on a holographic recording medium serving as a recordable medium having a recording layer in which a hologram is recorded using interference fringes caused by a signal light beam and a reference light beam.

2. Description of the Related Art

For example, Japanese Unexamined Patent Application Publication Nos. 2005-250038 and 2007-79438 describe holographic recording and reconstructing apparatuses that record data using interference fringes caused by a signal light beam and a reference light beam. In these holographic recording and reconstructing apparatuses, when data is recorded, a signal light beam subjected to spatial light modulation (e.g., light intensity modulation) in accordance with data to be recorded and a reference light beam different from the signal light beam are emitted into a holographic recording medium and form interference fringes caused by the two beams in the holographic recording medium. In this way, the data is recorded.

When the data is reconstructed, the reference light beam is emitted into the holographic recording medium. By emitting the reference light beam in this manner, a refracted light beam generated in accordance with the interference fringes formed in the holographic recording medium can be obtained, as described above. That is, in this way, a reconstructed light beam generated in accordance with the recorded data (i.e., a reconstructed signal light beam) is obtained. By detecting the reconstructed light beam obtained in this manner using a charge coupled device (CCD) or complementary metal-oxide semiconductor (CMOS) sensor, the recorded data can be reconstructed.

Like recording and reconstructing systems for existing optical disks, such as compact discs (CDs) and digital versatile discs (DVDs), the holographic recording and reconstructing apparatuses can record data along a track formed on a medium. That is, like existing optical discs, by controlling a recording and reconstruction position of data (e.g., tracking servo control), the holographic recording and reconstructing apparatuses can record data along a track.

In addition, in the holographic recording and reconstructing apparatuses, a two-dimensional image (a hologram page) including a plurality of binary values (“0” or “1” data) is recorded using interference between the signal light beam and the reference light beam. At that time, by recording the hologram pages in an overlapped manner (a multiplexed manner), the recording density can be increased. That is, the recording material of the holographic recording medium is changed from monomer to polymer so as to record data. Since the density of the monomers changed to polymers is low, an additional hologram page can be recorded at the same position until all of the monomers have been used for recording. Thus, hologram pages can be recorded in a multiplexed manner.

FIG. 15 schematically illustrates such hologram multiplexed recording. In FIG. 15, a solid line represents a track TR formed on a holographic recording medium. A hologram page is recorded so that the track TR is located at the center of the hologram page.

In addition, in this case, the holographic recording medium has a disc shape. The track TR is formed on the holographic recording medium in, for example, a spiral pattern or a concentric pattern. That is, in this case, a plurality of concentric tracks TR are arranged in a radial direction. In FIG. 15, only three tracks TR1 to TR3 of the plurality of concentric tracks TR arranged in the radial direction are extracted and shown.

As shown in FIG. 15, when hologram pages are recorded along the track TR using a hologram multiplexed recording method, the hologram pages are recorded so as to be overlapped in a line direction (a track forming direction). In addition to multiplexing in the line direction, multiplexing in the radial direction (a track arrangement direction) is employed. For example, when the amount of recorded data is relatively large and hologram pages are continuously recorded in a plurality of the tracks TR, the hologram pages recorded between the tracks TR are also overlapped. Thus, in order to record neighboring hologram pages in the radial direction so that the neighboring hologram pages are overlapped, the interval between the tracks TR (a track pitch) is predetermined so as to be less than the diameter of the hologram pages, as shown in FIG. 15.

### SUMMARY OF THE INVENTION

The above-described holographic recording and reconstructing apparatus has not been used for a commercial purpose. Currently, the recording format has yet to be decided.

The present invention describes a specific recording format used for holographic recording and reconstructing apparatuses. However, as described above, a recording format serving as an existing format is not found in the current situation.

Therefore, existing recording formats used for CDs and DVDs are used for a reference, and an optimum recording format for the holographic recording and reconstructing apparatuses is discussed below.

### CAV Method

First, as a most basic recording format, a constant angular velocity (CAV) method is discussed. As its name implies, in the CAV method, control is performed so that the angular velocity is constant. The CAV method has an advantage in that rotation control is simplified and random access is provided.

However, in the CAV method, when data is recorded at a constant data transfer rate, the line recording density is higher towards the inner periphery and is lower towards the outer periphery. As a result, the CAV method has a disadvantage in that the recording capacity is not efficiently increased and, therefore, the recording capacity remains low.

### CLV Method

In contrast, in order to increase the recording capacity to the maximum, a constant linear velocity (CLV) method is employed. As its name implies, in the CLV method, control is performed so that the linear velocity is constant. If data is recorded at a constant data transfer rate, the linear recording density can be constant from the inner periphery to the outer periphery.

However, in the CLV method, it is necessary that the spindle rotation speed is continuously changed from the inner periphery to the outer periphery, and therefore, the structure of a rotation control system is significantly complicated. In addition, when random access is performed, a wait time is necessary until the rotation of a disc is stabilized. With respect to this point, the CLV method has a disadvantage in terms of the performance of random access compared with the CAV method.

### MZ-CAV Method

An MZ-CAV method has the advantage of the CAV method that provides simplified control and the advantage of the CLV method that provides an increased recording capacity. More specifically, in the MZ-CAV method, the area of the disc from the inner periphery to the outer periphery is separated into several zones. Data is recorded at a constant spindle rotation speed while increasing the data transfer rate towards the outer zones. In such a case, since the CLV method is to be achieved, the relationship between the data transfer rate for each of the zones and the radius of the innermost periphery of the zone is expressed as follows:

data transfer rate=(linear recording density)×(radius of the innermost periphery)

The data transfer rate is determined so that the linear recording density of the innermost periphery of each of the zones is constant. Therefore, the MZ-CAV method has a problem of a nonconstant data transfer rate.

The descriptions of the above-described methods (the recording formats) indicate that the ideal recording format satisfies the following four conditions:

a) Maximized recording density,

b) Easy random access,

c) Constant data transfer rate, and

d) Simplified circuit configuration of the rotation control system.

That is, a recording format that satisfies the four conditions can be defined as an “ideal recording format”.

A summary of the advantages and disadvantages of the CAV, CLV, and MZ-CAV methods is shown in a table of FIG. 16.

The table shown in FIG. 16 also indicates that each of the recording formats used for existing optical disc recording and reconstructing apparatuses has advantages and disadvantages.

Accordingly, the present invention provides an ideal recording format that satisfies the above-described four conditions for holographic recording and reconstructing apparatuses by taking into account the differences between a recording and reconstructing apparatus for existing optical discs and the holographic recording and reconstructing apparatus.

To this end, the present invention provides a recording apparatus having the following configuration.

According to an embodiment of the present embodiment, a recording apparatus includes the following means. That is, the recording apparatus includes rotational drive means for rotationally driving a holographic recording medium, where the holographic recording medium includes a recording layer and a track forming layer. A signal light beam generated through spatial light modulation in accordance with data to be recorded and a reference light beam are emitted to the recording layer so that interference fringes are generated and a hologram is recorded in accordance with the signal light beam. The track forming layer includes guide tracks formed therein at constant intervals in a radial direction, and the guide tracks guides a recording position of the hologram in the recording layer. The recording apparatus further includes signal light beam generating means for generating the signal light beam by applying spatial light modulation to a light beam emitted from a light source in accordance with data to be recorded. The recording apparatus further includes reference light beam generating means for generating the reference light beam by applying spatial light modulation to a light beam emitted from a light source using a predetermined pattern. The recording apparatus further includes recording means for emitting the signal light beam generated by the signal light beam generating means and the reference light beam generated by the reference light beam generating means into the holographic recording medium and recording, in the holographic recording medium, a hologram in accordance with the signal light beam. The recording apparatus further includes rotation control means for controlling a rotational operation performed by the rotational drive means so that the holographic recording medium is rotationally driven at a constant rotation speed. The recording apparatus still further includes recording control means for selecting some of the guide tracks formed on the holographic recording medium so that radial-direction recording intervals of the holograms are statistically decreased towards an outer periphery of the holographic recording medium and controlling the recording means to record the holograms along the selected guide tracks.

Among the above-described four conditions for realizing an ideal format, the CAV rotation control method clearly satisfies the following three of the four conditions:

c) Constant data transfer rate,

b) Easy random access, and

d) Simplified circuit configuration of the rotation control system.

Accordingly, according to an embodiment of the present invention, the CAV method in which the holographic recording medium is rotated at a constant rotation speed is employed.

As for the remaining condition “Maximized recording density”, the CLV method provides a constant linear recording density, and therefore, provides a maximized recording density, as compared with the other rotation control methods. As can be seen from this description, if a constant recording density per unit area can be obtained for the entire disc, the recording density (the recording capacity) can be maximized.

Note that the recording density can be maximized using the CLV method only when existing optical discs that records data using information including a combination of a mark length (a pit length) and a space length are used. That is, a different situation occurs for the hologram recording and reconstructing apparatus.

As described above, the hologram recording and reconstructing apparatus is significantly different from the existing optical disc recording and reconstructing apparatuses in terms of the following points:

a) A hologram is recorded in the form of a two-dimensional image in which a plurality of binary values are arranged.

b) Holograms are recorded in a multiplexed manner, the holograms being shifted in the line direction relative to one another.

c) In addition to the line direction, holograms are recorded in a multiplexed manner, the holograms being shifted in the radial direction to one another.

Multiplex recording of holograms in the two-dimensional direction indicates that the surface recording density of the hologram recording and reconstructing apparatus can be determined by a combination of the line-direction recording density and the radial-direction recording density of holograms.

As described above, according to an embodiment of the present invention, the CAV method is employed for a rotation control method. In the CAV method, if holograms are recorded in a multiplexed manner while shifting the holograms in the line direction at constant angle intervals (i.e., at a constant data transfer rate), the line-direction recording capacity increases towards the inner periphery and decreases towards the outer periphery.

Due to such a characteristic regarding the line-direction recording capacity, a surface recording density of a constant value can be obtained by, in contrast to the above-described case, decreasing the recording interval of the holograms in the radial direction towards the inner periphery and increasing the recording interval towards the outer periphery. That is, when the CAV method is employed, the line-direction recording density decreases from high to low from the inner periphery towards the outer periphery (inner periphery—low; outer periphery—high). However, if the radial-direction recording density is set so as to increase from low to high from the inner periphery towards the outer periphery, the surface recording density can be maintained constant.

In order to increase the line-direction recording density from low to high from the inner periphery towards the outer periphery, the pitch of guide tracks formed on the recording medium can be gradually decreased towards the outer periphery. That is, by using a recording medium having such a structure and recording data along the tracks, data can be recorded so that the radial-direction recording density automatically increases from low to high from the inner periphery towards the outer periphery.

However, practically, it is difficult to form a guide track having a track pitch that decreases towards the outer periphery, since the control of formation of the tracks is difficult. That is, manufacturing of such a recording medium is difficult. In addition, for this reason, the manufacturing cost of the recording medium may increase.

Therefore, according to an embodiment of the present invention, a holographic recording medium including the tracks arranged at constant intervals in the radial direction is employed. In addition, the holographic recording medium having such a constant track pitch is rotationally driven using the CAV method. Furthermore, in order to record a hologram, one of the tracks is selected so that radial-direction recording intervals of the holograms are statistically decreased towards the outer periphery. Thereafter, the hologram is recorded along the selected track TR.

In this way, as in the case where the above-described recording medium having a track pitch that is decreased towards the outer periphery is used, the surface recording density of holograms can be made constant. That is, in hologram recording, a recording format that can maximize the recording density can be realized.

According to the above-described embodiment, by rotationally driving the holographic recording medium including guide tracks formed at a constant pitch and selecting one of the tracks along which a hologram is recorded so that the radial-direction recording interval of holograms is statistically decreased towards the outer periphery of the holographic recording medium, a recording format that satisfies the following four conditions can be realized:

a) Maximized recording density (high recording density),

b) Constant data transfer rate,

c) Easy random access, and

d) Simplified circuit configuration of the rotation control system.

That is, an “ideal recording format” that satisfies the four conditions can be realized.

### BRIEF DESCRIPTION OF THE DRAWINGS

FIG. 1 is a block diagram of an exemplary internal configuration of a recording apparatus according to an embodiment of the present invention;

FIG. 2 illustrates a cross-sectional structure of a holographic recording medium according to the embodiment of the present invention;

FIG. 3 illustrates a holographic recording medium when a track is formed in a spiral pattern;

FIG. 4 illustrates a holographic recording medium when a plurality of concentric tracks are formed;

FIG. 5 illustrates a recording method according to the present embodiment, in which a relationship between tracks formed on a holographic recording medium and holograms recorded along the tracks are schematically shown.

FIG. 6 shows a computation result of the track pitch (the number of formed tracks) between recording target tracks obtained using a first method;

FIGS. 7A and 7B show a computation result of the track pitch (the number of formed tracks) between recording target tracks obtained using a second method;

FIG. 8 shows exemplary information in a track number conversion table for the first method;

FIG. 9 shows exemplary information in a track number conversion table for the second method;

FIG. 10 is a flowchart illustrating the procedure of exemplary processing that realizes a recording operation according to the embodiment;

FIG. 11 illustrates a modification in which a track for recording address information is formed separately from a track for guiding a hologram recording position;

FIG. 12 illustrates another modification in which a track for recording address information is formed separately from a track for guiding a hologram recording position;

FIG. 13 illustrates another modification;

FIG. 14 illustrates an exemplary cross-sectional structure of a holographic recording medium used in the modification;

FIG. 15 is a schematic illustration of hologram multiplexed recording; and

FIG. 16 is a table illustrating the advantages and disadvantages of the CAV, CLV, and MZ-CAV methods.

### DESCRIPTION OF THE PREFERRED EMBODIMENTS

Various exemplary embodiments of the present invention are described below with reference to the accompanying drawings.

### Configuration of Recording Apparatus and Structure of Holographic Recording Medium

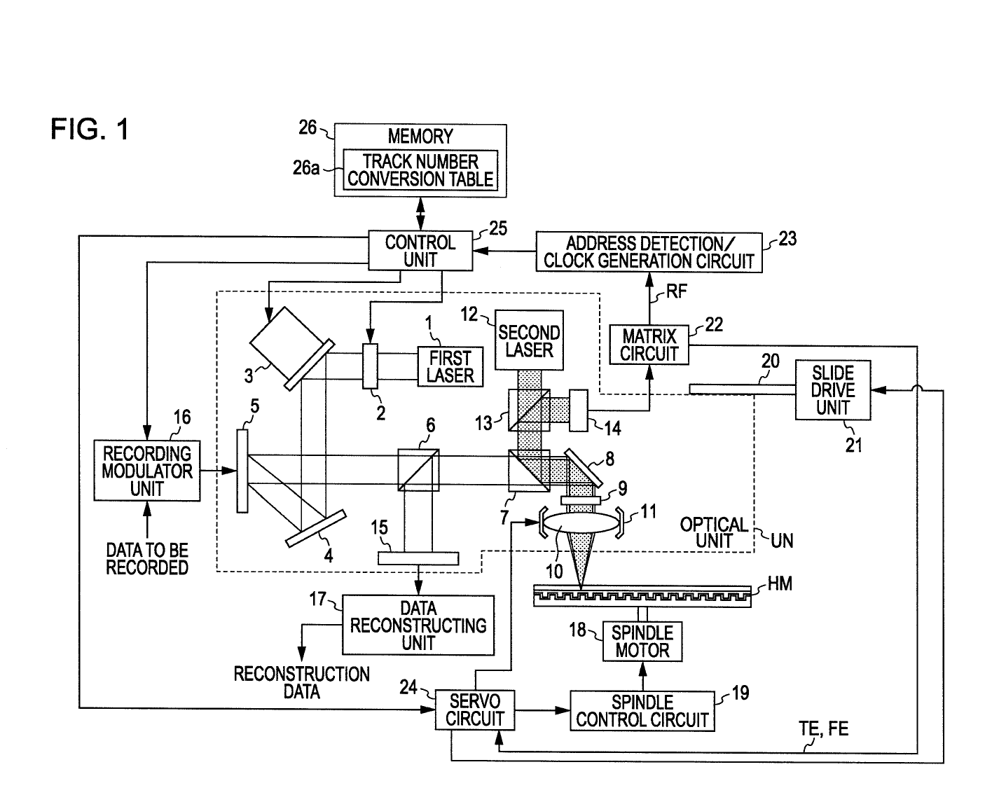

FIG. 1 is a block diagram of an internal configuration of a recording apparatus according to an embodiment of the present invention. According to the present embodiment, in addition to a function of recording data on a holographic recording medium HM, the recording apparatus has a function of reconstructing data. Therefore, hereinafter, the recording apparatus according to the present embodiment shown in FIG. 1 is referred to as a “recording and reconstructing apparatus”.

According to the present embodiment, in order to record and reconstruct a hologram, a method called a “coaxial method” is employed. That is, a signal light beam and a reference light beam are aligned on the same axis. These two beams are emitted into the holographic recording medium HM set at a predetermined location so that data is recorded using interference fringes. In addition, when data is reconstructed, the reference light beam is emitted into the holographic recording medium HM so that the data recorded using interference fringes is reconstructed.

In such a case, as shown in FIG. 1, the holographic recording medium HM has a disk shape. The recording and reconstructing apparatus rotationally drives the holographic recording medium HM and records or reconstructs data.

In this case, the holographic recording medium HM has a track formed in a spiral pattern or a concentric pattern. The recording and reconstructing apparatus operates so that data is recorded and reconstructed on and from the track formed in this manner. The holographic recording medium HM is described in more detail below.

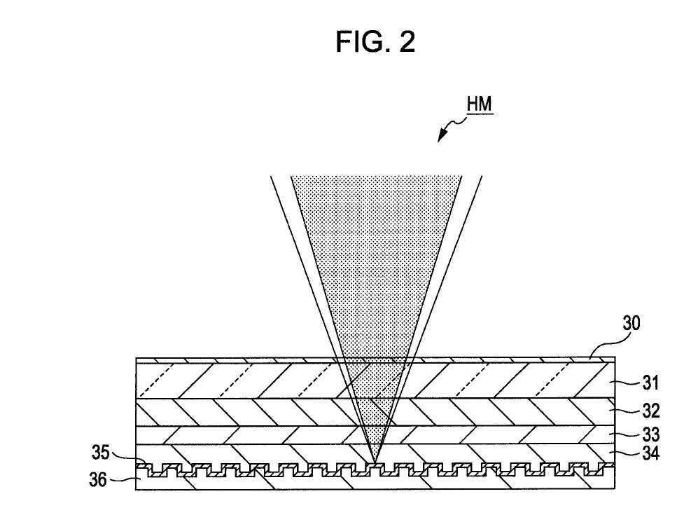

The structure of the holographic recording medium HM according to the present embodiment is described below with reference to FIGS. 2 to 4.

FIG. 2 illustrates a cross-sectional structure of the holographic recording medium HM.

In this example, the recording and reconstructing apparatus uses two different laser beams: a laser beam for recording a hologram using the interference fringes and a laser beam for controlling a recording and reconstructing position (a tracking servo) when recording and reconstructing the hologram along the track.

More specifically, the recording and reconstructing apparatus uses a first laser 1 and a second laser 12. The first laser 1 outputs a blue-violet laser beam having a wavelength of, for example, about 405 nm as a laser light source for recording and reconstructing data, while the second laser 12 outputs a red laser beam having a wavelength of, for example, about 650 nm as a laser light source for the position control.

Therefore, according to the present embodiment, as shown in FIG. 2, the holographic recording medium HM includes two different layers: a recording layer 32 into and from which hologram are recorded and reconstructed and a position control information recording layer having address information recorded therein using cross-sectional irregularity structure of a substrate 36. The address information is used for position control.

The cross-sectional structure of the holographic recording medium HM is described in more detail below.

As shown in FIG. 2, the holographic recording medium HM includes, from the top, an anti-reflecting film 30, a cover layer 31, a recording layer 32, a reflecting film 33, an interlayer 34, a reflecting film 35, and the substrate 36.

The anti-reflecting film 30 is formed through anti-reflection (AR) coating. The anti-reflecting film 30 has a function of preventing unwanted light reflection. The cover layer 31 is formed from a plastic substrate or a glass plate. The cover layer 31 is provided to protect the recording layer 32.

For example, the material of the recording layer 32 is photopolymers. As described above, recording and reconstruction are performed using a blue-violet laser beam emitted from the first laser 1 shown in FIG. 1 serving as a light source.

When the blue-violet laser beam serving as a reference light beam is emitted in order to reconstruct data and if a reconstruction light beam formed in accordance with interference fringes (data) recorded in the recording layer 32 is obtained, the reflecting film 33 returns the reconstruction light beam towards the recording and reconstructing apparatus in the form of a reflecting light beam.

The substrate 36 and the reflecting film 35 are provided for controlling the recording/reconstructing position. The track TR is formed on the substrate 36 in a spiral pattern or a concentric pattern in order to guide the recording/reconstructing position of a hologram to be formed in the recording layer 32. In this case, as described in more detail below, the track TR is formed by recording information, such as address information, using a sequence of pits.

The reflecting film 35 is formed over a surface (a front surface) of the substrate 36 having the track TR formed thereon by sputtering or vapor deposition. The interlayer 34 is formed between the reflecting film 35 and the reflecting film 33. The material of the interlayer 34 is an adhesive agent, such as a resin.

As can be seen from the descriptions above, in order to achieve appropriate position control using a red laser beam emitted from the second laser 12 serving as a light source, it is necessary that the red laser beam reaches the reflecting film 35 having a cross-sectional irregularity pattern for position control. That is, to this end, it is necessary that the red laser beam passes through the reflecting film 33 formed on top of the reflecting film 35.

In addition, it is necessary that the reflecting film 33 reflects a blue-violet laser beam in order to return a reconstruction light beam formed in accordance with the hologram recorded in the recording layer 32 towards the recording and reconstructing apparatus in the form of a reflected light beam.

Therefore, the reflecting film 33 formed between the recording layer 32 and the reflecting film 35 having the position control information recorded therein is configured so as to have wavelength selectivity that prohibits the blue-violet laser beam (a laser beam having a wavelength of, for example, about 405 nm) for hologram recording and reconstruction from passing therethrough and allows a red laser beam (a laser beam having a wavelength of, for example, about 650 nm) for position control to pass therethrough.

By providing such wavelength selectivity, the red laser beam can appropriately reach the reflecting film 35 at a recording and reconstruction time so that the reflected light information for position control is appropriately detected by the recording and reconstructing apparatus. In addition, a reconstruction light beam output from a hologram recorded in the recording layer 32 is appropriately detected by the recording and reconstructing apparatus.

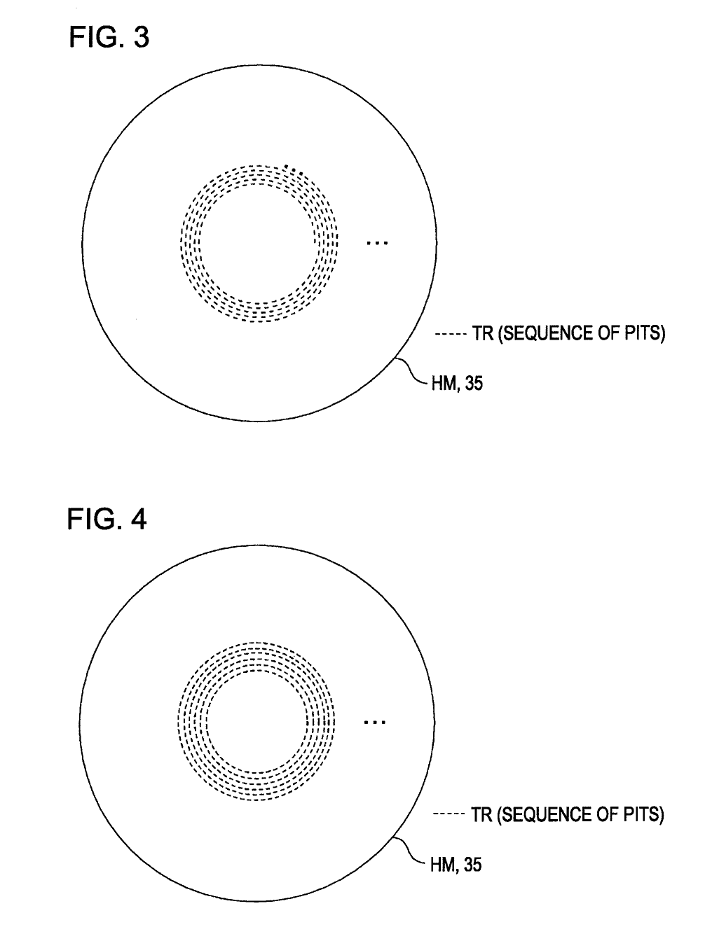

FIGS. 3 and 4 illustrate a guide track (the track TR) formed on the holographic recording medium HM. In FIGS. 3 and 4, the cross section of the holographic recording medium HM on the side of the reflecting film 35 is schematically shown when the holographic recording medium HM is cut between the interlayer 34 and the reflecting film 35. The reflecting film 35 has a cross-sectional irregularity pattern formed in accordance with the shape of a surface of the substrate 36, which is an underlayer of the reflecting film 35. The reflecting film 35 has the track TR formed thereon. Accordingly, the reflecting film 35 is also referred to as a “track forming layer”.

For example, in the holographic recording medium HM according to the present embodiment, the track TR is formed so as to have a spiral pattern, as shown in FIG. 3.

Alternatively, as shown in FIG. 4, a plurality of concentric tracks TR may be formed.

Note that a track TR that has a spiral pattern can be considered as a single continuous line. However, like a plurality of concentric tracks TR, as viewed in the radial direction, the track TR can be considered as a plurality of concentric tracks TR. In the case of the spiral pattern, the single continuous track has a recording start position (a rotation angle) for each of turns. Thus, the track TR is separated into different tracks each starting from the rotation angle.

According to the present embodiment, the track TR is formed by a sequence of pits that records address information.

The address information recorded as the sequence of pits includes track number information and a sector number information.

In this case, in the holographic recording medium HM, a sequential number is assigned to each of all of the tracks TR. The sequential number serves as the track number information. In addition, according to the present embodiment, each of the tracks TR is separated into the same number of sectors. More specifically, according to the present embodiment, each of the tracks TR is separated into 168 sectors.

As described in more detail below, according to the present embodiment, the CAV method is employed. Accordingly, the angles of the start positions of the sectors formed in the tracks TR are the same. In addition, the angles of the end positions of the sectors formed in the tracks TR are the same. That is, in this case, the sectors are radially formed in the tracks TR so as to have the same start angle and the same end angle.

The track number information is stored, for example, at the top of each of the sectors. In addition, the sector number information is stored at the position subsequent to the position at which the track number information is stored.

Furthermore, according to the present embodiment, the tracks TR are formed so as to have the same pitch in the radial direction over the entire surface of the disc. That is, the intervals at which tracks TR are formed in the radial direction is constant.

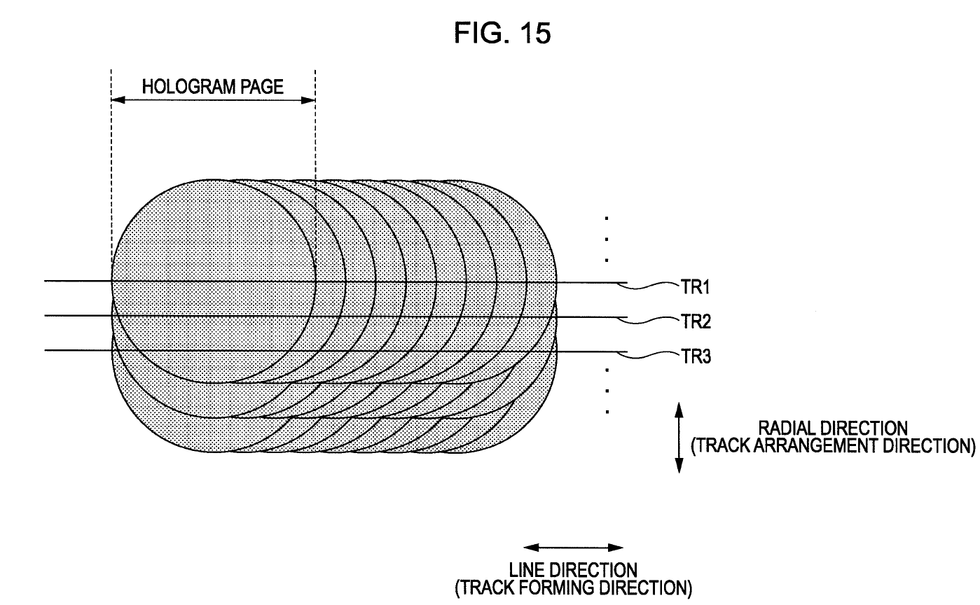

Still furthermore, the interval at which tracks TR are formed is determined so as to be less than at least the diameter of the hologram page. Thus, multiplexing of the holograms illustrated in FIG. 15 can be performed.

Referring back to FIG. 1, the recording and reconstructing apparatus includes a medium supporting unit (not shown) for supporting the holographic recording medium HM. When the holographic recording medium HM is mounted in the recording and reconstructing apparatus, the medium supporting unit supports the holographic recording medium HM so that a spindle motor 18 rotationally supports the holographic recording medium HM. In the recording and reconstructing apparatus, by emitting the laser beam output from the first laser 1 serving as a light source into the holographic recording medium HM that is rotationally driven, a hologram page can be recorded or reconstructed.

For example, a laser diode having an external oscillator is used for the first laser 1. As noted above, the wavelength of the laser beam is about 405 nm. Hereinafter, the laser beam output from the first laser 1 serving as a light source is referred to as a “first laser beam”.

The first laser beam output from the first laser 1 is made incident on a shutter 2. The open/close operation of the shutter 2 is controlled by a control unit 25 (described in more detail below) so that the incident light beam is blocked or transmitted.

The first laser beam that has passed through the shutter 2 is directed to a galvano mirror 3, as shown in FIG. 1. The galvano mirror 3 is provided to realize a function called an image stabilization function.

According to the present embodiment, the recording and reconstructing apparatus records a hologram by emitting a signal light beam and a reference light beam into the holographic recording medium HM that is rotatingly driven. At that time, in order to record the hologram generated by interference fringes between the signal light beam and the reference light beam, a certain response time is necessary for the recording material of the recording layer 32.

Therefore, in systems that record data on the rotating holographic recording medium HM, a laser beam is scanned in order to cause the position on the holographic recording medium HM at which the signal light beam and the reference light beam are emitted to remain unchanged for a certain period of time. More specifically, by changing the emission angle of the laser beam at a speed in synchronization with the rotation speed of the holographic recording medium HM (the rotation speed of the spindle motor 18), the emission spot of the signal light beam and the reference light beam can stay at a certain position for a certain period of time.

Under the control of the control unit 25, the galvano mirror 3 changes the emission angle of the reflected light beam of the incident light beam.

The light beam output from the galvano mirror 3 is reflected off a mirror 4 and is directed to a spatial light modulator (SLM) 5.

The SLM 5 performs spatial light modulation (e.g., spatial light intensity modulation) on the incident light beam. In such a case, the SLM 5 is of a reflective type. For example, a spatial light modulator, such as a digital micromirror device (DMD) (registered trademark) or a reflective liquid crystal panel, is used for the SLM 5.

By changing, using intensity modulating elements, the light intensity on the basis of a drive signal supplied from a recording modulator unit 16 shown in FIG. 1, the SLM 5 performs the spatial light intensity modulation on the incident light beam on a pixel-by-pixel basis.

By controlling drive of the SLM 5, the recording modulator unit 16 generates a signal light beam and a reference light beam when recording data and generates only a reference light beam when reconstructing data.

More specifically, for example, when recording data, the recording modulator unit 16 generates a drive signal that sets the pixels in a predetermined area including the center area of the SLM 5 (a signal light beam area) so that the pixels have an on/off pattern in accordance with supplied data to be recorded, sets the pixels in a predetermined area (referred to as a “reference light beam area”) on the outer periphery side from the signal light beam area so that the pixels have a predetermined on/off pattern, and sets all of the pixels in an area other than the above-described areas to off. Thereafter, the recording modulator unit 16 supplies the drive signal to the SLM 5. By performing spatial light intensity modulation on the basis of the drive signal, the SLM 5 generates the signal light beam and the reference light beam.

When reconstructing data, the recording modulator unit 16 drives the SLM 5 using a drive signal that sets the pixels in the reference light beam area so that the pixels have the above-described predetermined on/off pattern and sets all of the pixels in an area other than the reference light beam area to off. In this way, the SLM 5 generates only the reference light beam.

Note that when recording data, the recording modulator unit 16 generates an on/off pattern of the signal light beam area for each predetermined amount of input data to be recorded so that a signal light beam containing the predetermined amount of data of the above-described data string to be recorded is sequentially generated. In this way, the data for each of the hologram pages is sequentially recorded in the holographic recording medium HM.

The light beam subjected to the spatial light modulation by the SLM 5 passes through a polarizing beam splitter 6 and is made incident on a dichroic mirror 7.

The dichroic mirror 7 allows the first laser beam to pass therethrough. In addition, the dichroic mirror 7 reflects a second laser beam (a beam emitted from the second laser 12). Accordingly, the first laser beam that has passed through the polarizing beam splitter 6 passes through the dichroic mirror 7. Thereafter, as shown in FIG. 1, the first laser beam is reflected by a mirror 8 and passes through a ¼ wavelength plate 9. Subsequently, the first laser beam is emitted into the holographic recording medium HM via an objective lens 10 supported by a two-axis mechanism 11.

The two-axis mechanism 11 supports the objective lens 10 so that the objective lens 10 is movable in directions in which the objective lens 10 moves towards and away from the holographic recording medium HM (a focus direction) and in the radial direction of the holographic recording medium HM (a direction perpendicular to the focus direction, i.e., a tracking direction). The two-axis mechanism 11 includes a focus coil for moving the objective lens 10 in the focus direction and a tracking coil for moving the objective lens 10 in the tracking direction.

As described above, the first laser beam that has passed through the SLM 5 is emitted into the holographic recording medium HM via the objective lens 10. In accordance with the spatial light modulation performed by the SLM 5, a signal light beam and a reference light beam based on the first laser beam are generated. Therefore, when data is recorded, the signal light beam and the reference light beam are emitted into the holographic recording medium HM. By emitting the signal light beam and the reference light beam in the above-described manner, a diffraction grating (a hologram) is generated in the recording layer 32 by interference fringes between these two light beams. Thus, the data is recorded.

In contrast, when the data is reconstructed, only a reference light beam is emitted from the SLM 5. The reference light beam is emitted into the holographic recording medium HM through the above-described optical path. In this way, when a reference light beam is emitted into the holographic recording medium HM, a diffracted light beam (a reconstruction light beam) formed in accordance with the interference fringes is obtained. The obtained reconstruction light beam is reflected by the reflecting film 33 of the holographic recording medium HM and is returned to the apparatus as a reflected light beam.

The reflected light beam is transformed into a parallel light beam by the objective lens 10. The parallel light beam then passes through the ¼ wavelength plate 9 and is reflected by the mirror 8. The reflected light beam passes through the dichroic mirror 7 and is made incident on the polarizing beam splitter 6.

The polarizing beam splitter 6 reflects the incident reflected light beam. The light beam reflected by the polarizing beam splitter 6 is made incident on an image sensor 15, as shown in FIG. 1.

For example, a CCD sensor or a CMOS sensor is used for the image sensor 15. The image sensor 15 receives the reconstruction light beam that has passed through the above-described optical path. The image sensor 15 then converts the reconstruction light beam into an electrical signal so as to obtain an image signal. The image signal includes a 0/1 data pattern (i.e., an ON/OFF pattern of a light beam) provided to the signal light beam when the data is recorded. That is, the image signal detected by the image sensor 15 in this manner corresponds to a readout signal of the data recorded in the holographic recording medium HM.

A data reconstructing unit 17 acquires the value of each of the pixels of the SLM 5 from the image signal detected by the image sensor 15 and determines whether the value is “0” or “1”. Thus, the data reconstructing unit 17 reconstructs the data recorded in the holographic recording medium HM.

As shown in FIG. 1, the recording and reconstructing apparatus further includes an optical system for controlling the recording and reconstruction position when the above-described recording/reconstructing operation is performed on the hologram using the first laser beam. More specifically, the optical system includes the second laser 12, a polarizing beam splitter 13, and a photodetector 14.

The second laser 12 emits a laser beam having a wavelength different from that of the first laser beam 1. More specifically, the second laser 12 emits a laser beam having a wavelength of about 650 nm, as described above.

Note that, in this case, the difference between the wavelengths of the first laser beam 1 and the second laser beam 12 is about 250 nm.

Since such a sufficient difference between the wavelengths is provided, the laser beam emitted from the second laser 12 serving as a light source (i.e., the second laser beam) has negligible sensitivity to the recording layer 32 of the holographic recording medium HM.

The second laser beam emitted from the second laser 12 passes through the polarizing beam splitter 13 and is reflected by the dichroic mirror 7. The second laser beam is then directed to the mirror 8. The second laser beam directed to the mirror 8 passes through a path similar to that of the above-described first laser beam and is emitted to the holographic recording medium HM.

As can be seen from the description above, the dichroic mirror 7 has a function of making the optical paths of the first laser beam and the second laser beam equal and emitting the first laser beam and the second laser beam to the holographic recording medium HM.

As illustrated in FIG. 2, in the holographic recording medium HM, the emitted second laser beam passes through the reflecting film 33 and is reflected by the reflecting film 35, which is the underlayer of the reflecting film 33. That is, in this manner, a reflected light beam including information about the cross-sectional irregularity pattern (a sequence of pits) on the reflecting film 35 can be obtained.

As in the case of the first laser beam, the reflected light beam from the reflecting film 35 travels via the objective lens 10, the ¼ wavelength plate 9, and the mirror 8 and is made incident on the dichroic mirror 7.

The dichroic mirror 7 reflects the reflected light beam of the second laser beam from the holographic recording medium HM. The reflected light beam is then directed to the polarizing beam splitter 13. The polarizing beam splitter 13 reflects the reflected light beam from the holographic recording medium HM. The reflected light beam is then directed to the photodetector 14.

The photodetector 14 includes a plurality of light receiving elements. The photodetector 14 receives the reflected light beam directed from the holographic recording medium HM in the above-described manner. The photodetector 14 then converts the reflected light beam into an electrical signal and supplies the electrical signal to a matrix circuit 22.

The matrix circuit 22 includes a matrix computation/amplifier circuit for signals output from the plurality of light receiving elements of the photodetector 14. The matrix circuit 22 generates necessary signals through a matrix computation process.

For example, the matrix circuit 22 generates a signal (a reconstruction signal RF) corresponding to a reconstruction signal generated from a sequence of pits formed in the holographic recording medium HM, a focus error signal FE, and a tracking error signal TE used for servo control.

The reconstruction signal RF is output from the matrix circuit 22 and is supplied to an address detection/clock generation circuit 23. The focus error signal FE and the tracking error signal TE are supplied to a servo circuit 24.

The address detection/clock generation circuit 23 detects address information on the basis of the reconstruction signal RF. In addition, the address detection/clock generation circuit 23 generates a clock.

When the address detection/clock generation circuit 23 detects (reconstructs) address information, the address detection/clock generation circuit 23 detects the above-described track number information and sector number information.

When the address detection/clock generation circuit 23 generates a clock, the address detection/clock generation circuit 23 performs a PLL process on the basis of the reconstruction signal RF so as to generate a reconstruction clock.

The address information detected (reconstructed) by the address detection/clock generation circuit 23 is supplied to the control unit 25. Although not shown, the clock information is supplied to various components that use the clock information in the form of an operating clock.

A spindle control circuit 19 controls the rotation of the spindle motor 18. According to the present embodiment, the CAV method is employed as a method for controlling the rotation of the spindle motor 18 (the rotation of the holographic recording medium HM). The spindle control circuit 19 rotates the spindle motor 18 at a constant speed.

As shown in FIG. 1, a slide mechanism 20 supports an optical unit UN so that the optical unit UN is slidable in the tracking direction (the radial direction of the holographic recording medium HM). In this case, the optical unit UN includes the first laser 1, the shutter 2, the galvano mirror 3, the mirror 4, the SLM 5, the polarizing beam splitter 6, the dichroic mirror 7, the mirror 8, the ¼ wavelength plate 9, the objective lens 10, the two-axis mechanism 11, the second laser 12, the polarizing beam splitter 13, the photodetector 14, and the image sensor 15 formed therein. The slide mechanism 20 is provided so as to slidably support the optical unit UN, and the optical unit UN is slidable in the radial direction of the holographic recording medium HM.

A slide drive unit 21 includes a motor for driving the slide mechanism 20. The slide mechanism 20 is configured so as to slidably move the optical unit UN using the driving force of the motor.

The servo circuit 24 generates a focus servo signal, a tracking servo signal, and a thread servo signal on the basis of the focus error signal FE and the tracking error signal TE output from the matrix circuit 22. The servo circuit 24 then performs a servo control operation.

That is, the servo circuit 24 generates the focus servo signal and the tracking servo signal in accordance with the focus error signal FE and the tracking error signal TE and supplies the focus servo signal and the tracking servo signal as drive signals for the two-axis mechanism 11 (a focus drive signal and a tracking drive signal). Thus, the focus coil and the tracking coil of the two-axis mechanism 11 are controlled by the drive signals in accordance with the servo signals. In this way, a tracking servo loop and a focus servo loop are formed from the photodetector 14, the matrix circuit 22, the servo circuit 24, and the two-axis mechanism 11.

In addition, in response to a track jump instruction received from the control unit 25, the servo circuit 24 changes the tracking servo loop to off and outputs a jump pulse serving as the tracking drive signal. Thus, a track jumping operation is performed.

Furthermore, the servo circuit 24 instructs the slide drive unit 21 to slidably move the slide mechanism 20 on the basis of the thread error signal obtained as a low-frequency component of the tracking error signal TE and seek operation control performed by the control unit 25. In this way, the servo circuit 24 slidably moves the entire optical unit UN.

Still furthermore, the servo circuit 24 starts and stops the operation of the spindle motor 18 on the basis of an instruction received from the control unit 25.

The above-described operations performed by the servo system is controlled by the control unit 25 formed from a microcomputer including a central processing unit (CPU), a read only memory (ROM), and a random access memory (RAM).

The control unit 25 performs a variety of computing and control processes on the basis of programs stored in a memory 26 shown in FIG. 1 so as to perform overall control of the recording and reconstructing apparatus.

For example, the control unit 25 controls the operations of the above-described servo system so as to control the recording/construction position of a hologram.

More specifically, when data recorded in the holographic recording medium HM is reconstructed, the control unit 25 specifies a target address and controls a seek operation. That is, the control unit 25 sends the target address to the servo circuit 24 and instructs the servo circuit 24 to perform an access operation of a target point using that address. Here, as described above, when data (a hologram) recorded in the holographic recording medium HM is reconstructed, it is necessary that a reference light beam based on the first laser beam is emitted. Accordingly, when the data is reconstructed, in addition to controlling the above-described seek operation, the control unit 25 controls the recording modulator unit 16 so that the SLM 5 performs an operation corresponding to the above-described reconstruction operation and generates a reference light beam.

In contrast, when data is recorded in the holographic recording medium HM at a specific position, the control unit 25 sends the target address to the servo circuit 24 so that the servo circuit 24 performs an access operation to the target address. In addition, the control unit 25 instructs the recording modulator unit 16 to start driving of the SLM 5 in accordance with the data to be recorded.

Furthermore, when data is recorded, the above-described open/close operation of the shutter 2 is performed. Still furthermore, the galvano mirror 3 is controlled so that a scan operation of a laser beam serving as an image stabilization function is performed.

In order to control the galvano mirror 3, the angle of the mirror is changed so that the output angle of the laser beam is changed towards a predetermined direction (a direction that is the same as the disc rotation direction) at a predetermined speed. Thereafter, the mirror is returned to the opposite direction. Such control is repeatedly performed. In addition, in order to control the shutter 2, the shutter 2 is opened during the predetermined-speed beam output angle control period (i.e., a period during which a spot is stationary on a medium, or a recording period during which a hologram page is recorded), whereas the shutter 2 is closed during a period other than the predetermined-speed beam output angle control period.

Note that, according to the above-described control, a period during which no beam is emitted appears between hologram recording periods. However, the above-described control can prevent formation of an unwanted recorded portion between holograms recorded in the holographic recording medium HM.

### Recording Operation According to Embodiment

As noted above, any holographic recording and reconstructing apparatus has not been used for a commercial purpose. In addition, a recording format used for holographic recording and reconstructing apparatuses has not yet been determined.

As can be seen from the description above, according to the present embodiment, the recording and reconstructing apparatus records and reconstructs a hologram while rotating a disc-shaped recording medium, which is similar to an existing optical disc, such as a CD or a DVD. Accordingly, for the recording format of the recording and reconstructing apparatus, the format used for existing optical discs can be employed.

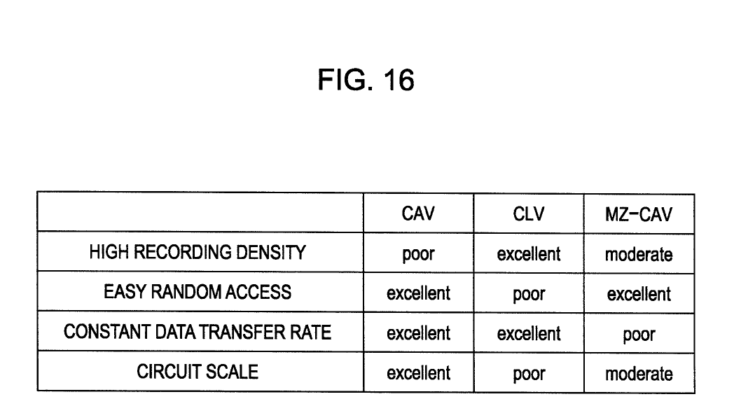

However, as illustrated in FIG. 16, since each of the CAV method, the CLV method, and the MZ (multi zone)-CAV method employed for existing optical discs has an advantage and a disadvantage, none of the formats is ideal.

The ideal recording format is a format that satisfies the following four conditions:

a) Maximized recording density (high recording density),

b) Easy random access,

c) Constant data transfer rate, and

d) Simplified circuit configuration of the rotation control system.

None of the existing formats satisfies all of the four conditions.

Accordingly, the present embodiment provides an ideal recording format that satisfies the above-described four conditions for holographic recording and reconstructing apparatuses while taking into account the differences between an existing optical-disc recording and reconstructing apparatus and the hologram recording and reconstructing apparatus (more specifically, the difference between the factors for determining a signal-to-noise ratio (SNR)).

Among the above-described four conditions, the CAV method satisfies the following three conditions:

b) Easy random access,

c) Constant data transfer rate, and

d) Simplified circuit configuration of the rotation control system.

Accordingly, as described above, according to the present embodiment, the CAV method is employed.

In order to derive a requirement for satisfying the condition “Maximized recording density” for the hologram recording and reconstructing apparatus, the case in which the condition is satisfied for existing optical discs is discussed below.

For existing optical discs, the track pitch is basically constant. This is because since the width of a beam emitted when data is recorded is constant, the width of a formed track is constant. Accordingly, if the track pitch is not a minimized constant value slightly larger than the track width, the recording density is decreased.

For existing optical discs, the shortest mark length (the shortest recording wavelength) λ that provides the minimized SNR is determined in accordance with a track width tw. In addition, the linear recording density is in inverse proportion to the shortest mark length λ. That is, the linear recording density is proportional to 1/λ.

Furthermore, a surface recording density d is determined by the linear recording density and the track pitch. For simplicity, assume that the track pitch is the same as the track width. Then, the surface recording density d is proportional to 1/(λ·t). That is, d∝1/(λ·t).

When the shortest mark length is denoted by λ, v=λν, where v denotes the linear velocity, and ν denotes the data transfer rate. Here, the relationship between an angular velocity a and the linear velocity v is expressed as:

v=2πr·a,

where r denotes a radial position.

The above description indicates that, for existing optical discs, when employing the CLV method in which the angular velocity a (the rotation speed) is changed in inverse proportion to the radial position r, the surface recording density d can be maximized by appropriately determining the linear velocity v, the data transfer rate ν, and the shortest mark length λ.

In contrast, as can be seen from the description above, the hologram recording and reconstructing apparatus is significantly different from the existing optical disc recording and reconstructing apparatuses in terms of the following points:

a) A hologram is recorded in the form of a two-dimensional image in which a plurality of binary values are arranged.

b) Holograms are recorded in a multiplexed manner, the holograms being shifted in the line direction relative to one another.

c) In addition to the line direction, holograms are recorded in a multiplexed manner, the holograms being shifted in the radial direction to one another.

In the hologram recording and reconstructing apparatus that records holograms in a multiplexed manner in the two-dimensional direction, the surface recording density d is proportional to c/(pa·pt), where c=data capacity of a hologram page, pa=recording interval of holograms in the line direction, and pt=recording interval of holograms in the radial direction.

In the hologram recording and reconstructing apparatus, two-dimensional multiplexed recording is performed. Accordingly, in addition to pa, pt serves as an adjustable parameter for determining the surface recording density (and the SNR). Therefore, when the surface recording density is determined so that a certain constant SNR is obtained, the values of pa and pt can be freely determined under the condition that the product of pa and pt is constant.

According to the present embodiment, as described above, the CAV method is employed for a rotation control method. In the CAV method, if holograms are recorded in a multiplexed manner while shifting the holograms in the line direction at constant angle intervals (i.e., at a constant data transfer rate), the line-direction recording capacity increases towards the inner periphery and decreases towards the outer periphery.

Due to such a characteristic regarding the line-direction recording capacity, a surface recording density of a constant value can be obtained by, in contrast to the above-described case, decreasing the recording interval of the holograms in the radial direction towards the inner periphery and increasing the recording interval towards the outer periphery. That is, when the CAV method is employed, the line-direction recording density decreases from high to low from the inner periphery towards the outer periphery (inner periphery—low; outer periphery—high). However, if the radial-direction recording density is set so as to increase from low to high from the inner periphery towards the outer periphery, the surface recording density can be maintained constant.

In order to increase the line-direction recording density from low to high from the inner periphery towards the outer periphery, the pitch of the guide tracks (the tracks TR) formed on the recording medium can be gradually decreased towards the outer periphery. That is, by using a recording medium having such a structure and recording data along the tracks TR, data can be recorded so that the radial-direction recording density increases from low to high from the inner periphery towards the outer periphery.

However, practically, it is difficult to form a guide track having a track pitch that decreases towards the outer periphery, since the control of formation of the track TR is difficult. That is, manufacturing of such a recording medium is difficult. In addition, for this reason, the manufacturing cost of the recording medium may increase.

Therefore, according to the present embodiment, as illustrated in FIGS. 3 and 4, the holographic recording medium HM including the tracks TR arranged at constant intervals in the radial direction is employed.

In addition, according to the present embodiment, the holographic recording medium HM having such a constant track pitch is rotationally driven at a constant rotation speed. Furthermore, in order to record a hologram, one of the tracks TR is selected so that the hologram recording interval statistically decreases towards the outer periphery. Thereafter, the hologram is recorded along the selected track TR.

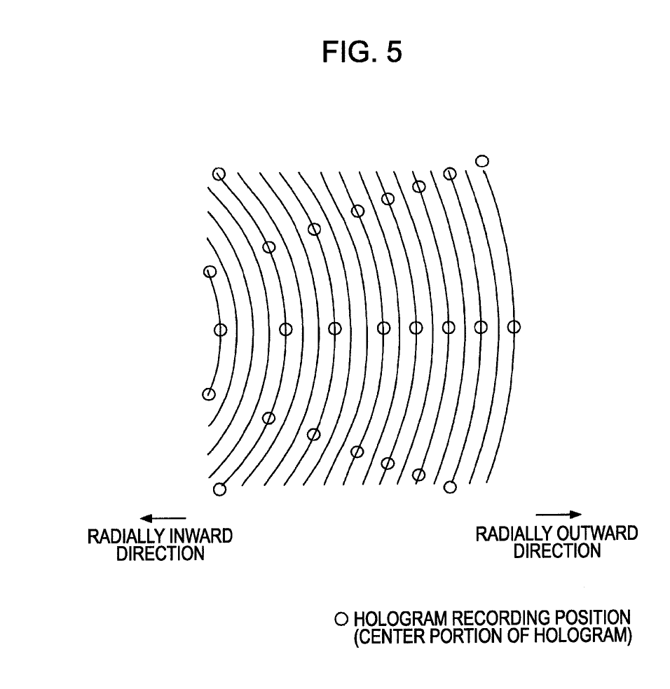

FIG. 5 illustrates such a recording method according to the present embodiment. In FIG. 5, the relationship between each of the tracks TR formed on the holographic recording medium HM and a hologram recorded along the track TR is schematically shown. Note that, in FIG. 5, only part of the holographic recording medium HM is retrieved and shown.

For simplicity, in FIG. 5, only the center portions of recorded holograms are shown by circles. However, in practice, the entire holograms are recorded in a multiplexed manner in the line direction and the radial direction, as shown in FIG. 15.

By using the above-described recording method according to the present embodiment as shown in FIG. 5, the hologram recording interval in the radial direction can be increased in the inner peripheral portion and can be decreased in the outer peripheral portion.

As mentioned earlier, according to the present embodiment, the CAV method is employed. That is, the holographic recording medium HM is rotationally driven at a constant rotation speed, and holograms are recorded at a constant interval (time interval).

Note that, when data is recorded using the CAV method, the positions (the angles) on the tracks TR at which holograms are recorded are the same, as shown in FIG. 5. That is, when viewed from the top of the disc, the holograms are recorded in a radial pattern.

According to the above-described recording method of the present embodiment, a track TR used for a recording operation is selected from among the tracks TR formed on the holographic recording medium HM and, subsequently, a hologram is recorded using the selected track TR.

To keep the following discussion clear, hereinafter, the tracks TR formed on the holographic recording medium HM are referred to as “formed tracks”. A track TR selected from among formed tracks TR so as to be used for actually recording a hologram is referred to as a “recording target track”.

In addition, as can be seen from the description above, in the recording method according to the present embodiment, it is important that a “recording target track” is selected so that the radial-direction recording interval is statistically decreased towards the outer periphery.

In order to statistically decrease the radial-direction recording interval towards the outer periphery, the number of the formed tracks between selected recording target tracks can be statistically inversely proportional to the radial position.

Particular methods for selecting a recording target track so that the radial-direction recording interval is statistically decreased towards the outer periphery is described below.

### First Method

In order to select a recording target track, the value of a radial position at which a hologram is recorded (the value of the radius of the position at which the hologram is recorded) is first computed when the radial-direction recording interval of the holograms is inversely proportional to the radial position.

In this example, parameters having the following values are used for computation:

r₀: a radial position of a hologram recorded at the innermost periphery . . . 20 mm,

P₀: a hologram interval at the innermost periphery . . . 15 μm, and

gp: a formed track pitch . . . 1 μm.

The radial position r₀ of a hologram recorded at the innermost periphery represents the value of a radius to a hologram recorded on the track TR at the innermost periphery (i.e., the radial position of the track TR at the innermost periphery). The hologram interval P₀ at the innermost periphery represents the interval between the track TR at the innermost periphery (or a hologram recorded on the track) and the next track on which a hologram is subsequently recorded (or a hologram recorded on the next track). That is, the hologram interval P₀ at the innermost periphery represents the interval between a first recording target track and a second recording target track.

The formed track pitch gp represents the interval between the tracks formed on the holographic recording medium HM (i.e., a track pitch).

Note that the above-described values of the parameters are only examples. An important point is that, in order to compute the radial position of each of the holograms using the above-described method, it is necessary that the values of the parameters are predetermined.

When the radial-direction recording interval between holograms is inversely proportional to the radius, the value of the radial position of the hologram can be computed as follows. That is, the radial position rᵢ of an ith hologram can be computed as follows:

$${r}_{i} = {r}_{i - 1} + \frac{{r}_{0} \cdot {P}_{0}}{{r}_{i - 1}} \qquad ( 1 )$$

By using equation (1) and the radial position of the second hologram, the radial position of each of the holograms is sequentially computed.

Subsequently, according to the first method, the number Tn of the tracks TR between an (i−1)th hologram and the ith hologram (i.e., a track pitch of the recording target tracks) is computed as follows:

$$Tn = Round [ \frac{{r}_{i} - {r}_{i - 1}}{gp} ] \qquad ( 2 )$$

where Round[ ] is a function of returning the nearest integer (a rounded integer).

That is, in the first method, by rounding the distance between neighboring holograms, a recording target track is selected.

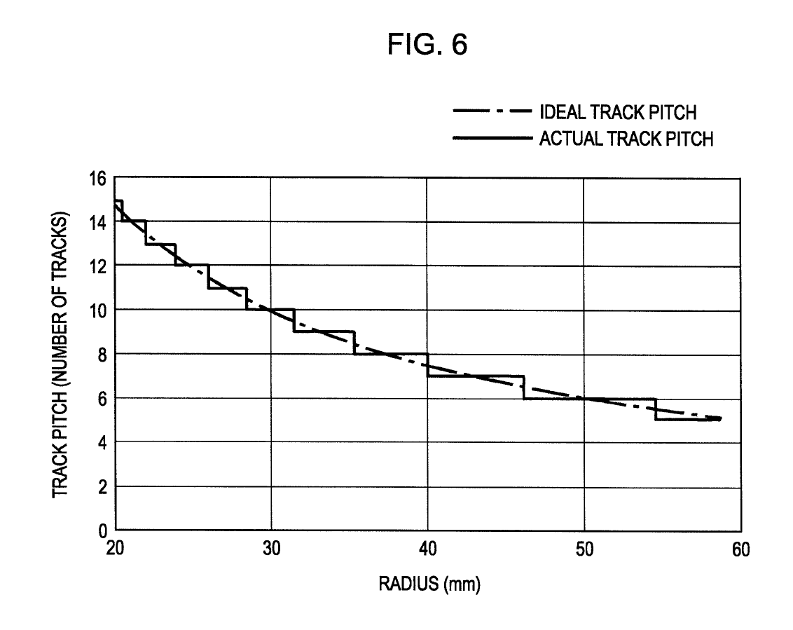

FIG. 6 shows a computation result of the track pitch (the number of formed tracks) between the recording target tracks obtained using equation (2). In FIG. 6, the abscissa represents the radius, and the ordinate represents a track pitch (the number of formed tracks). The relationship between a radial position and the actual track pitch obtained through the computation is shown using a solid line.

Note that, in FIG. 6, an ideal track pitch is shown, as a reference, using an alternate long and short dash line. The ideal track pitch is the track pitch (the number of formed tracks) calculated on the basis of the information on the radial position of each of the holograms obtained using equation (1) without being rounded.

As can be seen from FIG. 6, according to the first method, the actual track pitch obtained through computation is statistically equal to the ideal track pitch. Therefore, according to the first method, each recording target track can be selected so that the radial-direction recording interval of the holograms statistically decreases towards the outer periphery.

### Second Method

In a second method, the radial position of a hologram is rounded.

Like the first method, the information on the radial position of each hologram is computed using equation (1).

According to the second method, after the radial position of each hologram is computed, the number Tn of the tracks TR between an (i−1)th hologram and an ith hologram is computed as follows:

$$Tn = Round [ \frac{{r}_{i} - {r}_{0}}{gp} ] - Round [ \frac{{r}_{i - 1} - {r}_{0}}{gp} ] \qquad ( 3 )$$

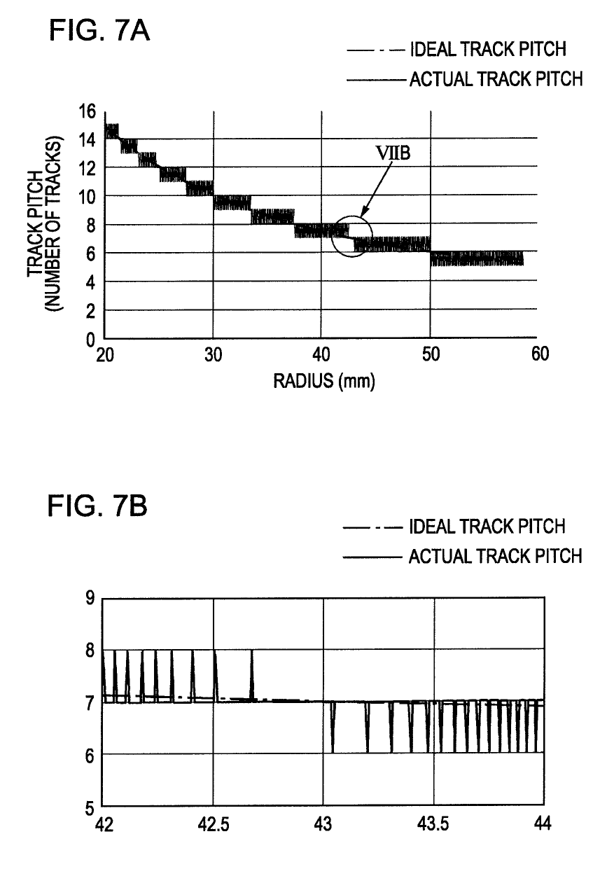

FIG. 7A shows a computation result of the track pitch (the number of formed tracks) between the recording target tracks obtained using equation (3). As in FIG. 6, in FIGS. 7A and 7B, the abscissa represents the radius, and the ordinate represents a track pitch (the number of formed tracks). The relationship between a radial position and the actual track pitch obtained through the computation is shown using a solid line.

FIG. 7B is an enlarged view of a part VIIB of FIG. 7A (i.e., the computation result when the radial position is in the range from 42 mm to 44 mm).

Note that, as in FIG. 6, in FIGS. 7A and 7B, an ideal track pitch is shown using an alternate long and short dash line. The ideal track pitch is computed in the same manner as in FIG. 6.

As can be seen from the result shown in FIGS. 7A and 7B (in particular, FIG. 7A), according to the second method, like the first method, the actual track pitch obtained through computation is statistically equal to the ideal track pitch. Therefore, each recording target track can be selected so that the radial-direction recording interval of the holograms statistically decreases towards the outer periphery.

By computing the value of the track pitch (the number of formed tracks) between recording target tracks using one of the above-described two methods, a track TR that is to serve as a recording target track can be selected from among the tracks (the formed tracks) TR formed on the holographic recording medium HM.

In summary, in order to determine an actual recording format, the line-direction recording density is determined after, in the above-described manner, the recording target tracks are selected so that the number of formed tracks is statistically inversely proportional to the radius (i.e., after the radial-direction recording density is determined). More specifically, the line-direction recording density (the disc rotation speed and the data transfer rate) is determined in accordance with the radial-direction recording density so that, for example, the surface recording density predetermined while taking into account the SNR can be obtained.

After the recording target track is selected in this manner, the recording and reconstructing apparatus selects the recording target track and records a hologram on the track. In this way, the recording operation according to the present embodiment can be realized.

The recording and reconstructing apparatus shown in FIG. 1 prestores a track number conversion table 26a in a memory 26. The track number conversion table 26a serves as information used for selecting the recording target truck.

The track number conversion table 26a contains information for identifying which one of the tracks TR formed on the holographic recording medium HM is a recording target track. More specifically, the track number conversion table 26a represents a correspondence between the track number of each of the recording target tracks and the track number of one of the tracks TR formed on the holographic recording medium HM.

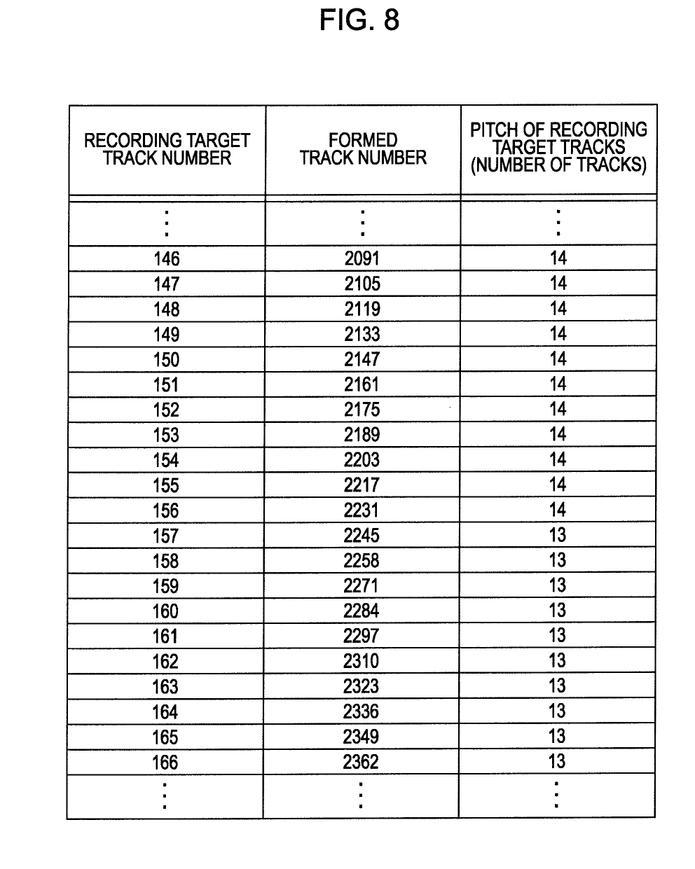

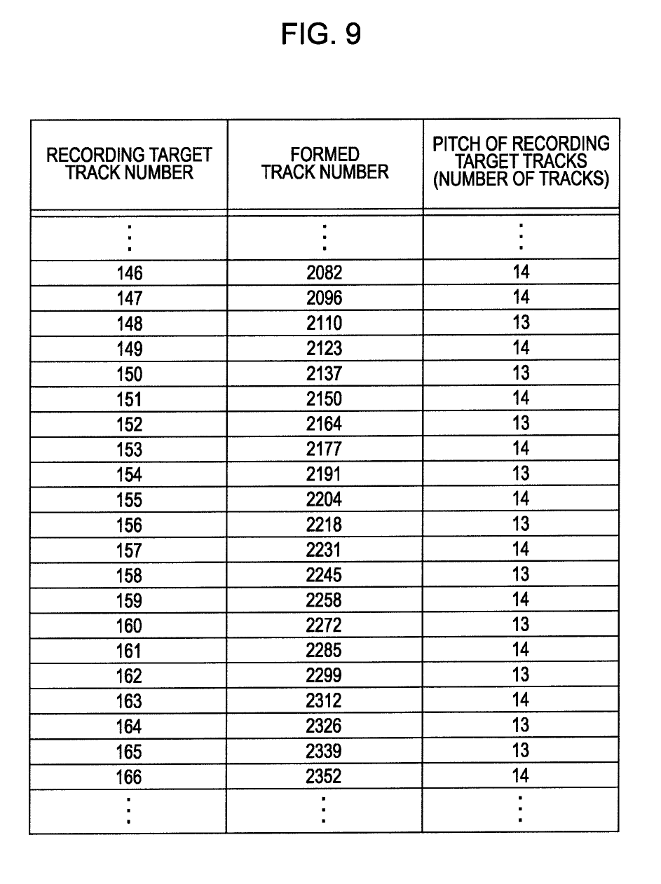

FIGS. 8 and 9 illustrate an example of information contained in the track number conversion table 26a. FIG. 8 illustrates information when recording target tracks are selected using the above-described first method, whereas FIG. 9 illustrates information when recording target tracks are selected using the above-described second method.

Note that FIGS. 8 and 9 illustrate only part of the information contained in the track number conversion table 26a.

As shown in FIGS. 8 and 9, the track number conversion table 26a contains the correspondence between the track number of a recording target track (a sequential number of the recording target track when counted from the innermost periphery; hereinafter referred to as a “recording target track number”) and the track number of a formed track (i.e., the track number of the above-described track TR; hereinafter referred to as a “formed track number”).

In addition, according to the present embodiment, the track number conversion table 26a contains corresponding pitch information (the number of tracks) of the recording target tracks. As shown in FIGS. 8 and 9, the pitch information of the recording target tracks has a one-to-one correspondence with a recording target track. The pitch information of the recording target tracks indicates the number of formed tracks located between the corresponding recording target track and the next recording target track.

The pitch information of the recording target tracks can be used as information indicating the number of formed tracks to be jumped when track jumping between the recording target tracks is performed.

The control unit 25 shown in FIG. 1 controls a recording operation on the basis of the track number conversion table 26a so that a hologram is recorded on the recording target track. Thus, holograms can be recorded so that the radial-direction recording intervals of the holograms are statistically decreased towards the outer periphery.

### Processing Procedure

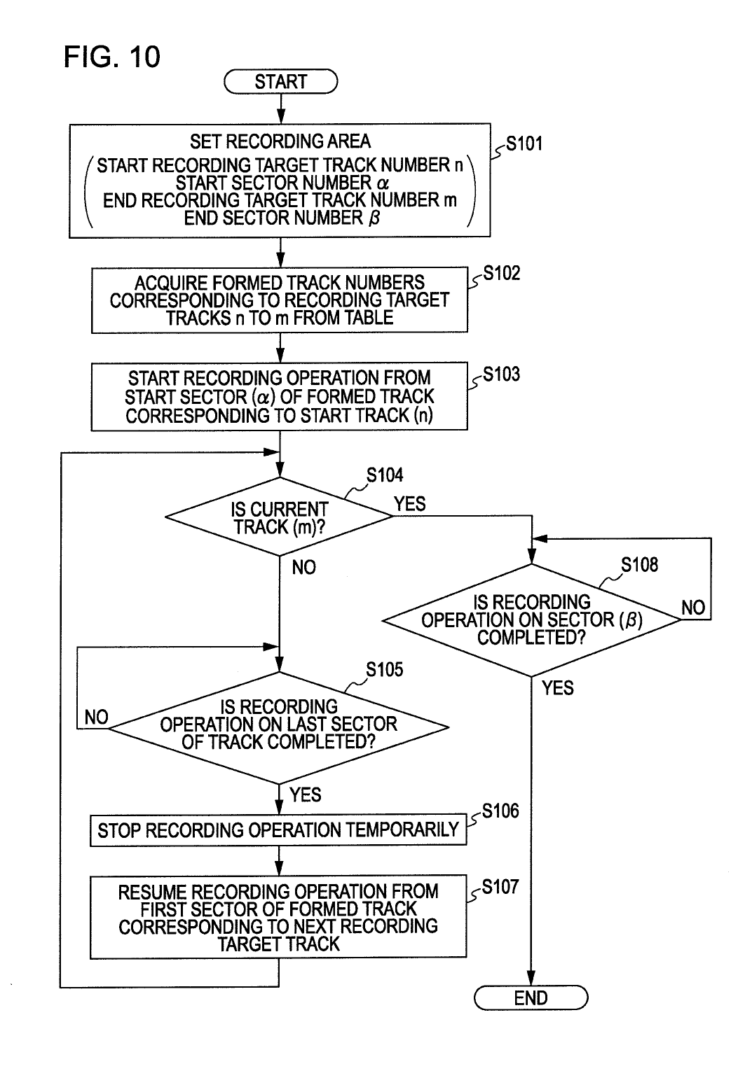

An exemplary procedure of processing performed by the recording and reconstructing apparatus that realizes the recording operation according to the present embodiment is described next with reference to FIG. 10.

FIG. 10 illustrates the procedure of exemplary processing that realizes the recording operation according to the present embodiment and that is performed by the control unit 25 shown in FIG. 1 on the basis of a program (not shown) stored in the memory 26.

First, in step S101, a recording area is determined.

When data is recorded in the holographic recording medium HM, information regarding an area in which the data is to be recorded is set on the basis of the data recording state and the recording capacity of data of the holographic recording medium HM. When data recording in the holographic recording medium HM is ready, such setting of the recording area is performed in step S101.

More specifically, as shown in FIG. 10, the following information items are set:

a) start recording target track number n,

b) start sector number α,

c) end recording target track number m, and

d) end sector number β.

Note that the start recording target track number n serves as recording target track number information used for identifying a recording target track from which recording is to be started. The start sector number αserves as sector number information used for identifying a sector on the start recording target track, that is, the sector from which recording is to be started. Similarly, the end recording target track number m serves as recording target track number information used for identifying a recording target track at which recording is to be ended. The end sector number β serves as sector number information used for identifying a sector on the end recording target track, the sector at which recording is to be ended.

After the recording area setting process performed in step S101 is completed, the formed track numbers corresponding to the recording target tracks n to m are acquired from the table in step S102.

That is, from the track number conversion table 26a as shown in FIG. 8 or 9, track number information regarding the recording target tracks located between the start recording target track n and the start recording target track m are acquired.

In step S103, processing for starting recording data from the start sector (α) on the formed track corresponding to the start track (n) is performed. That is, control is performed so that a recording operation is started from the sector having the start sector number α on the recording target track having the start recording target track number n.

More specifically, the formed track number information corresponding to the start recording target track (n) acquired in step S102 and the start sector number information (α) are sent to the servo circuit 24 as target address information. Thus, the servo circuit 24 is instructed to perform an access operation at the target address. In addition, the recording modulator unit 16 is instructed to start driving the SLM 5 in accordance with the data to be recorded. Furthermore, the above-described open/closed operation of the shutter 2 and drive control of the galvano mirror 3 are started.

In step S104, it is determined whether the current track is the track m. That is, it is determined whether the recording target track number of the current recording target track is equal to the end recording target track number m.

If, in step S104, the current track is not the track m, the processing proceeds to step S105.

In step S105, the processing waits until a recording operation on the last sector of the track is completed. For example, since the number of sectors per track is 168 in this example, the processing waits in step S105 until a recording operation on the sector having a sector number 168, which is the last sector on the track, is completed.

Upon completion of the recording operation on the last sector, processing for temporarily stopping the recording operation is performed in step S106. That is, the recording modulator unit 16 is instructed to stop driving the SLM 5, and the shutter 2 is closed. Thus, the recording operation is temporarily stopped.

In step S107, processing for resuming the recording operation from a first sector of the formed track corresponding to the next recording target track is performed. That is, a formed track number corresponding to the next recording target track and the sector number information regarding a first sector of the next recording target track (e.g., a sector number (1)) are sent to the servo circuit 24 as target address information. Thus, the servo circuit 24 is instructed to perform an access operation at the target address. In addition, the recording modulator unit 16 is instructed to start a control operation of the SLM 5 in accordance with the data to be recorded. Furthermore, the open/closed operation of the shutter 2 and drive control of the galvano mirror 3 are resumed.

After the processing performed in step S107 is completed, the processing returns to step S104, where the above-described determination is made.

By repeating the series of processing from step S104 to step S104 via steps S105, S106, and S107, holograms are recorded on the recording target tracks located in the recording area.

However, if, in step S104, it is determined that the current track is the track (m), the processing proceeds to step S108, where the processing waits until the recording operation on the sector (β) is completed. That is, the processing waits until the recording operation on the sector having the above-described end sector number β is completed.

After the recording operation on the sector (β) is completed, the processing procedure shown in FIG. 10 is completed.

By performing the recording control as illustrated in FIG. 10, holograms can be recorded in the holographic recording medium HM so that the radial-direction recording intervals of the holograms is statistically decreased towards the outer periphery.

That is, by using such recording control according to the present embodiment, in the case where holograms are recorded using the CAV method under the condition of a constant rotation speed and a constant data transfer rate (a constant recording interval), the surface recording density of holograms can be made constant. As a result, a recording format that can maximize the recording density can be provided.

In addition, since, as described above, the recording and reconstructing apparatus according to the present embodiment employs the CAV method, an ideal recording format that satisfies all of the following four conditions can be provided:

a) Maximized recording density,

b) Easy random access,

c) Constant data transfer rate, and

d) Simplified circuit configuration of the rotation control system.

Furthermore, according to the present embodiment, the holographic recording medium HM having the tracks TR formed at a constant pitch is used. Accordingly, an existing manufacturing step for forming the tracks TR can be employed. As a result, manufacturing of a recording medium is facilitated. In addition, the recording medium can be manufactured without an increase in manufacturing cost.

### Modifications

While the present invention has been described with reference to the embodiment of the present invention, the present invention is not limited thereto.

For example, in the description above, a recording target track is selected using the table information in the track number conversion table 26a. However, a recording target track can be selected through computation.

In such a case, for example, by prestoring track pitch information about the tracks (formed tracks) TR, rotation speed information about the spindle motor 18, and the data transfer rate information (the interval of the holograms in the line direction) in the memory 26, the recording target tracks can be computed using these parameters so that the desired surface recording density is obtained.

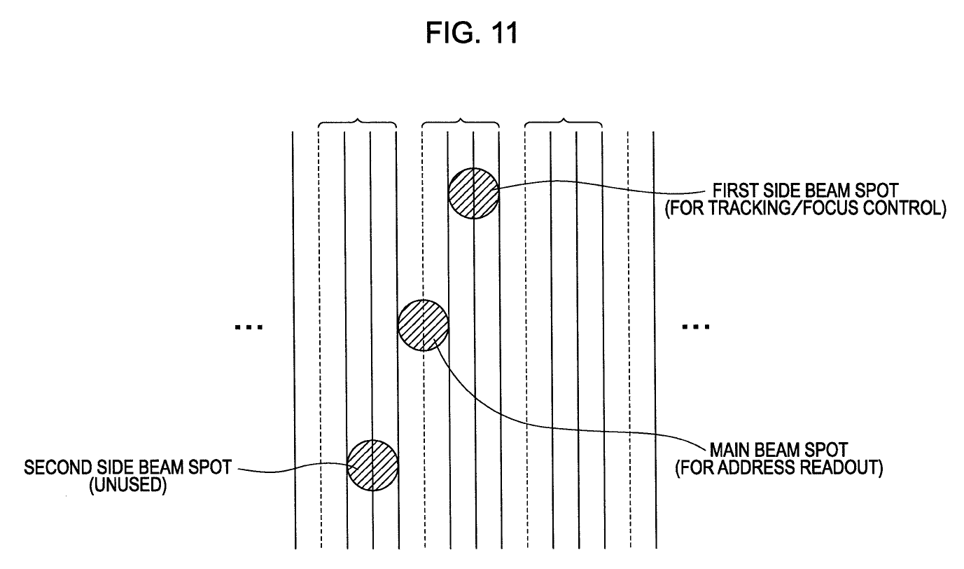

In addition, in the description above, a track formed from a single sequence of pits are used for a recording function of address information and a guide function of the recording position of a hologram. However, for example, as shown in FIG. 11, a track for recording address information may be formed separately from a track for guiding a hologram recording position.

In the example shown in FIG. 11, in addition to a track formed from a sequence of pits for recording address information, three DC grooves (a continuous groove) are formed between the tracks formed from sequences of pits. That is, in this case, it can be considered that a track formed from a sequence of pits and three DC grooves form a set.

In the example shown in FIG. 11, a red laser beam used for position control is separated into three sub-beams, as shown in FIG. 11. In this case, the address information recorded in the sequence of pits is read out using a main beam spot located in the middle. In addition, one of two side beam spots (a first side beam spot) is used for a tracking servo and a focus servo based on the three DC grooves.

In this case, the distance between the main beam spot and the first side beam spot in the radial direction is controlled so that, when the first side beam spot traces the middle DC groove of the three DC grooves, as shown in FIG. 11, the main beam spot traces the sequence of pits. In this way, by performing tracking servo control using the first side beam spot, the main beam spot can trace the sequence of pits.

Note that, in this case, the other side beam spot (a second side beam spot) is not used.

The optical axis of the blue-violet laser beam used for recording and reconstructing a hologram is controlled so as to be aligned with the main beam spot. Accordingly, in the example shown in FIG. 11, a hologram is formed on the sequence of pits.

In the example shown in FIG. 11, the position of the main beam spot is determined by the tracking servo based on the DC groove, and a hologram is recorded at a position the same as that of the main beam spot. Accordingly, in this case, the track of the DC groove serves as a guide track for guiding the recording position of a hologram.

That is, in this case, if the DC grooves serving as a guide track are formed at constant intervals in the radial direction and, in addition, the sequence of pits is formed along the DC grooves with a predetermined distance therebetween (a distance between the first side beam spot and the main beam spot), the hologram can be recorded on the sequence of pits at a position identified by the address information.

In order to satisfy such conditions, in the example shown in FIG. 11, the track of the sequence of pits and the track of the DC groove are formed so as to be located at constant intervals.

As can be seen from the description above, in the example shown in FIG. 11, a hologram is not recorded on the guide track. However, a hologram is still recorded at a position along the guide track. Accordingly, if the DC grooves serving as a guide track are formed at constant intervals in the radial direction, the above-described recording operation according to the present embodiment can be performed, and therefore, the advantages of a constant surface recording density can be still obtained.

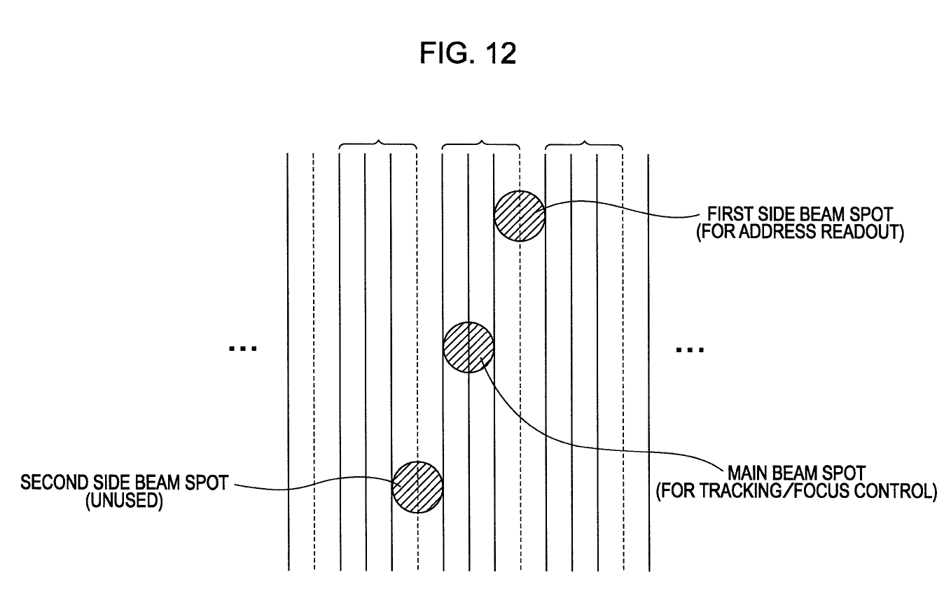

Like the example shown in FIG. 11, in an example shown in FIG. 12, a track formed from a sequence of pits and a track formed from DC grooves are formed. However, in this example, the address information on the sequence of pits is read out using the first side beam spot, and the tracking servo and focus servo control is performed using the main beam spot.

As noted above, a hologram is recorded at a position the same as that of the main beam spot. Accordingly, in this case, the hologram is recorded on the DC groove. In addition, since the tracking servo control is performed on the basis of the DC groove, a track based on the DC groove serves as a track for guiding the recording position of the hologram.

Like the example shown in FIG. 11, a hologram is recorded on the guide track in this case. Therefore, if the DC grooves serving as a guide track are formed at constant intervals in the radial direction, the above-described recording operation according to the present embodiment can be performed, and therefore, the same advantages can be obtained.

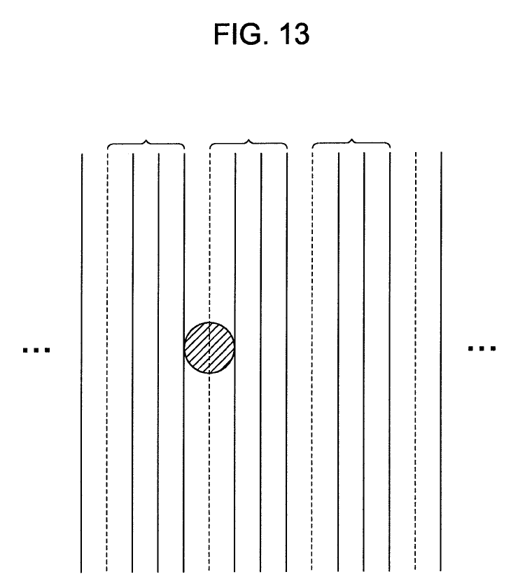

In an example shown in FIG. 13, position control is performed on the holographic recording medium HM having one of the structures shown in FIGS. 11 and 12 using one beam spot. That is, in this case, like the recording and reconstructing apparatus shown in FIG. 1, the address information on the sequence of pits is read out, and the tacking servo and focus servo control based on a sequence of pits is performed by using a single beam spot.

While the foregoing description has been made with reference to recording of the address information using a sequence of pits, the address information can be recorded by periodically changing the width of a groove and using the information about the period. Alternatively, the address information can be recorded by changing the depth of a groove and using information indicating the difference between the depths.

In either case, the address information can be recorded by using only a groove. Accordingly, a sequence of pits formed along the groove as shown in FIG. 12 is unnecessary.

In addition, while the foregoing description has been made with reference to the case where recording (reconstruction) of a hologram and the position control are performed using different laser light sources having different wavelengths, recording (reconstruction) of a hologram and the position control can be performed using only a laser light source for recording the hologram.

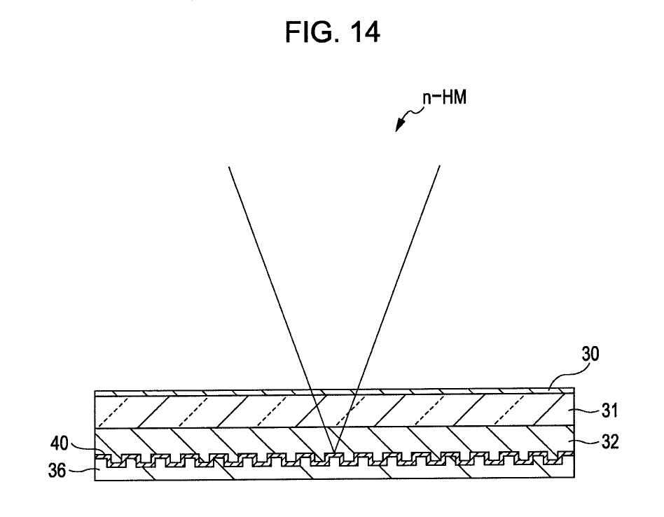

FIG. 14 illustrates an exemplary cross-sectional structure of a holographic recording medium used in such a case (hereinafter referred to as a “holographic recording medium n-HM”).

Unlike the holographic recording medium HM shown in FIG. 2, the holographic recording medium n-HM has no reflecting film 33 and interlayer 34. In addition, in this case, a reflecting film 40 that reflects a laser beam for recording and reconstructing a hologram is used for a reflecting film formed on the substrate 36. The recording layer 32 is formed on the reflecting film 40.

By changing the configuration of the optical system so that a light beam reflected by the holographic recording medium n-HM is directed to the image sensor 15 and the photodetector 14, a hologram can be recorded and reconstructed, and control of the position of the hologram can be performed using only a laser light source for recording the hologram.

Note that if a hologram is recorded on a track formed from a sequence of pits, a change in a reconstruction light beam of the hologram may occur in accordance with the irregularity of the sequence of pits, and therefore, the detection accuracy of the reconstruction light beam of the hologram may be degraded. Accordingly, like the examples shown in FIGS. 11 and 12, the beam is separated into sub-beams. Readout of address information recorded in a track formed from a sequence of pits and tracking servo control are performed using a side beam, and recording and reconstruction of a hologram is performed by a main beam. Thus, that problem can be avoided. That is, by using such a technique, a hologram is recorded at a position separated from the sequence of pits by a predetermined distance (a distance between a side beam spot and the main beam spot). Therefore, the hologram can be reconstructed without being subjected to interference by the sequence of pits.

Furthermore, while the foregoing description has been made with reference to only the case where recording and reconstruction of a hologram are performed on a reflective holographic recording medium having a reflecting film, the present invention is also applicable to a transmissive holographic recording medium having no reflecting film.

When a transmissive holographic recording medium is used, the polarizing beam splitter 6 (and the ¼ wavelength plate 9) for directing a reconstruction image obtained as a reflected light beam formed in accordance with an emitted reference light beam to the image sensor 15 can be removed from the recording and reconstructing apparatus. In addition, the polarizing beam splitter 13 for directing a reflected light beam reflected from a layer having a track formed therein (a reflected light beam for position control) to the photodetector 14 can be removed from the recording and reconstructing apparatus.

In such a case, the reconstruction light beam obtained in accordance with emission of the reference light beam passes through the entire holographic recording medium HM. Accordingly, an additional objective lens is disposed on the opposite side of the holographic recording medium from the emission point of the laser beam, and the reconstruction light beam that has passed through the holographic recording medium HM can be directed to the image sensor 15 via the additional objective lens. Similarly, a reconstruction light beam of the position control laser beam that has passed through the track forming layer passes through the entire holographic recording medium HM. Accordingly, the reconstruction light beam that has passed through the holographic recording medium HM can be directed to the photodetector 14 via the additional objective lens.

Still furthermore, while the foregoing description has been made with reference to a coaxial method in which a reference light beam and a signal light beam are aligned on the same axis and the recording is performed, the present invention is also applicable to a method called a “two-beam method” in which, when data is recorded, a reference light beam and a signal light beam are independently emitted.

In such a case, the recording and reconstructing apparatus can separately include a set of a light source for generating a signal light beam when data is recorded and an SLM and a set of a light source for generating a reference light beam and an SLM. In addition, the recording and reconstructing apparatus can include the optical system having a structure modified so that the signal light beam and the reference light beam generated by the different sets are directed into the holographic recording medium at different angles.

The present application contains subject matter related to that disclosed in Japanese Priority Patent Application JP filed in the Japan Patent Office on Jun. 24, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A recording apparatus comprising:
rotational drive means for rotationally driving a holographic recording medium, the holographic recording medium including a recording layer and a track forming layer, a signal light beam generated through spatial light modulation in accordance with data to be recorded and a reference light beam being emitted to the recording layer so that interference fringes are generated and a hologram is recorded in accordance with the signal light beam, the track forming layer including guide tracks formed therein at constant intervals in a radial direction, the guide tracks guiding a recording position of the hologram in the recording layer;
signal light beam generating means for generating the signal light beam by applying spatial light modulation to a light beam emitted from a light source in accordance with data to be recorded;
reference light beam generating means for generating the reference light beam by applying spatial light modulation to a light beam emitted from a light source using a predetermined pattern;
recording means for emitting the signal light beam generated by the signal light beam generating means and the reference light beam generated by the reference light beam generating means into the holographic recording medium and recording, in the holographic recording medium, a hologram in accordance with the signal light beam;
rotation control means for controlling a rotational operation performed by the rotational drive means so that the holographic recording medium is rotationally driven at a constant rotation speed; and
recording control means for selecting some of the guide tracks formed on the holographic recording medium so that radial-direction recording intervals of the holograms are statistically decreased towards an outer periphery of the holographic recording medium and controlling the recording means to record the holograms along the selected guide tracks.

2. The recording apparatus according to claim 1, further comprising:
storage means for storing recording target track identification information for indicating, from among the guide tracks formed on the holographic recording medium, the guide tracks on which the holograms are to be recorded so that radial-direction recording intervals of the holograms are statistically decreased towards an outer periphery of the holographic recording medium;
wherein the recording control means selects, using the recording target track identification information, the guide tracks along which the holograms are to be recorded.

3. The recording apparatus according to claim 2, wherein the guide tracks on the holographic recording medium are formed from a sequence of pits that records address information therein, and wherein the recording apparatus further includes address information reconstructing means for reconstructing the address information recorded on the guide track in the form of the sequence of pits.

4. The recording apparatus according to claim 2, wherein the guide track on the holographic recording medium is formed from a continuous groove, and a sequence of pits that records address information therein is formed along the guide track in the form of the continuous groove, and wherein the recording apparatus further includes position controlling means for performing control so that an emission point of the signal light beam and the reference light beam traces the guide track formed in the form of the continuous groove and address information reconstructing means for reconstructing the address information recorded using the sequence of pits.

5. A recording method comprising the steps of:
rotationally driving a holographic recording medium, the holographic recording medium including a recording layer and a track forming layer, a signal light beam generated through spatial light modulation in accordance with data to be recorded and a reference light beam being emitted to the recording layer so that interference fringes are generated and a hologram is recorded in accordance with the signal light beam, the track forming layer including guide tracks formed therein at constant intervals in a radial direction, the guide tracks guiding the recording position of the hologram in the recording layer;
generating the signal light beam by applying spatial light modulation to a light beam emitted from a light source in accordance with data to be recorded;
generating the reference light beam by applying spatial light modulation to a light beam emitted from a light source using a predetermined pattern; and
selecting some of the guide tracks formed on the holographic recording medium so that radial-direction recording intervals of the holograms are statistically decreased towards an outer periphery of the holographic recording medium and recording the holograms along the selected guide tracks by emitting the generated signal light beam and the generated reference light beam into the holographic recording medium.

6. A recording apparatus comprising:
a rotational drive unit configured to rotationally drive a holographic recording medium, the holographic recording medium including a recording layer and a track forming layer, a signal light beam generated through spatial light modulation in accordance with data to be recorded and a reference light beam being emitted to the recording layer so that interference fringes are generated and a hologram is recorded in accordance with the signal light beam, the track forming layer including guide tracks formed therein at constant intervals in a radial direction, the guide tracks guiding the recording position of the hologram in the recording layer;
a signal light beam generating unit configured to generate the signal light beam by applying spatial light modulation to a light beam emitted from a light source in accordance with data to be recorded;
a reference light beam generating unit configured to generate the reference light beam by applying spatial light modulation to a light beam emitted from a light source using a predetermined pattern;
a recording unit configured to emit the signal light beam generated by the signal light beam generating unit and the reference light beam generated by the reference light beam generating unit into the holographic recording medium and recording, in the holographic recording medium, a hologram in accordance with the signal light beam;
a rotation control unit configured to control a rotational operation performed by the rotational drive unit so that the holographic recording medium is rotationally driven at a constant rotation speed; and
a recording control unit configured to select some of the guide tracks formed on the holographic recording medium so that radial-direction recording intervals of the holograms are statistically decreased towards an outer periphery of the holographic recording medium and control the recording unit to record the holograms along the selected guide tracks.
